(19) United States
(12) Patent Application Publication
(10) Pub. No.: US 2010/0002121 A1
(43) Pub. Date: Jan. 7, 2010

(54) SOLID-STATE IMAGING DEVICE AND ELECTRONIC APPARATUS

(75) Inventor: Takeshi Fujioka, Kanagawa (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/494,829

(22) Filed: Jun. 30, 2009

(30) Foreign Application Priority Data
Jul. 2, 2008 (JP) 2008-173625

(51) Int. Cl. H04N 5/335

(52) U.S. Cl. 348/314

(57) ABSTRACT

A solid-state imaging device includes a plurality of light sensing sections disposed arranged two-dimensionally in rows and columns, each light sensing section performing photoelectric conversion, a vertical transfer register section placed so as to correspond to each of the columns of the light sensing sections, a horizontal transfer register section, and a vertical overflow drain structure placed at the last stages of the vertical transfer register sections adjacent to the horizontal transfer register section.

### BACKGROUND OF THE INVENTION

1. Field of the Invention

The present invention relates to solid-state imaging devices, and in particular, relates to a CCD solid-state imaging device and an electronic apparatus including the CCD solid-state imaging device.

2. Description of the Related Art

CCD solid-state imaging devices are well known as solid-state imaging devices used in electronic apparatuses, such as a digital still camera, a digital video camera, and a camera-equipped mobile phone. A typical CCD solid-state imaging device includes a plurality of light sensing sections, arranged two-dimensionally in rows and columns, for performing photoelectric conversion, a vertical transfer register section with a CCD structure placed so as to correspond to each of the columns of the light sensing sections, and a horizontal transfer register section having the CCD structure connected to the last stage of each vertical transfer register section. Each light sensing section, serving as a pixel, includes a photodiode. The last stage of the horizontal transfer register section is connected to an output section which outputs a pixel signal through a charge-to-voltage conversion section.

In the CCD solid-state imaging device, during a light receiving storage period, light incident on each light sensing section is converted into a signal charge according to the amount of incident light and the signal charge is stored in the light sensing section. Upon reading, the signal charge is read out from the light sensing section to the corresponding vertical transfer register section. The read-out signal charges are transferred on a row-by-row basis in the vertical transfer register sections during part of a horizontal blanking period and are then transferred to the horizontal transfer register section. Each transferred signal charge is transferred in the horizontal transfer register section and is then converted into a voltage at the last stage of the horizontal transfer register section. The voltage is output as a pixel signal from the output section.

Some CCD solid-state imaging devices adapt a so-called vertical overflow drain structure in which excess charges generated in the light sensing sections at the time when a large amount of light is received and signal charges stored in the light sensing sections until electronic shuttering are discharged to a substrate of the device. Such CCD solid-state imaging devices having the above-described vertical overflow drain structure are disclosed in, for example, Japanese Unexamined Patent Application Publication Nos. 6-339081, 2001-308310, and 2000-311995.

Furthermore, in the CCD solid-state imaging devices, the amount of charge handled in each vertical transfer register section decreases as the pixels become smaller. Accordingly, a phenomenon called “blooming” easily occurs upon reception of a large amount of light. Japanese Unexamined Patent Application Publication No. 2007-142696 discloses a CCD solid-state imaging device in which part of signal charges is allowed to flow to a substrate by controlling a substrate voltage simultaneously with or before reading out the signal charges from light sensing sections to vertical transfer register sections in order to prevent blooming.

The CCD solid-state imaging devices with the vertical overflow drain structure are generally constructed so that an electronic shutter pulse necessary for electronic shuttering is applied to the substrate. In the solid-state imaging device disclosed in Japanese Unexamined Patent Application Publication No. 2007-142696, it is necessary to provide a substrate pulse having a voltage different from that of the electronic shutter pulse. Specifically, when excess charges are allowed to overflow to the substrate, a bias voltage depending on chip is applied to the substrate in order to control the amount of saturation signal of each photodiode serving as a light sensing section. In order to control the overflow upon reading out signal charges to the vertical transfer register sections, therefore, a first overflow potential for overflow from the photodiodes, serving as the light sensing sections, and a second overflow potential different from the first overflow potential have to be set.

A variation in the second overflow potential significantly affects the amount of charge stored in each vertical transfer register section. Accordingly, a mechanism for increasing controllability of the second overflow potential has to be devised. However, the controllability becomes very difficult, especially as unit pixels become smaller.

### SUMMARY OF THE INVENTION

In the CCD solid-state imaging devices, when a large amount of light is received, the following phenomenon occurs. Unnecessary charges, serving as smear signals, are generated in the vertical transfer register sections and are not stored by the vertical transfer register sections, so that the unnecessary charges are transferred to the horizontal transfer register section. Such a problem causes an image defect. In the CCD solid-state imaging devices, it is therefore desirable to remove unnecessary charges, serving as smear signals, in the vertical transfer register sections.

In consideration of the above-described problem, it is desirable to provide a solid-state imaging device in which unnecessary charges, serving as smear signals, in vertical transfer register sections are prevented from being transferred to a horizontal transfer register section. It is further desirable to provide an electronic apparatus including the solid-state imaging device.

According to an embodiment of the present invention, a solid-state imaging device includes a plurality of light sensing sections arranged two-dimensionally in rows and columns, each light sensing section performing photoelectric conversion, a vertical transfer register section placed so as to correspond to each of the columns of the light sensing sections, a horizontal transfer register section, and a vertical overflow drain structure placed at the last stages of the vertical transfer register sections adjacent to the horizontal transfer register section.

According to this embodiment, the solid-state imaging device includes the vertical overflow drain structure at the last stages of the vertical transfer register sections. Accordingly, in the case where charges obtained by adding unnecessary charges to signal charges are transferred in the vertical transfer register sections, when the unnecessary charges reach transfer portions at the last stages of the vertical transfer register sections, the vertical overflow drain structure allows the unnecessary charges to flow in the depth direction of the substrate of the device.

According to another embodiment of the present invention, an electronic apparatus includes a solid-state imaging device, an optical system that guides incident light to light sensing sections of the solid-state imaging device, a driving circuit that drives the solid-state imaging device, and a signal processing circuit that processes an output signal of the solid-state imaging device. The solid-state imaging device includes the light sensing sections arranged two-dimensionally in rows and columns, each light sensing section performing photoelectric conversion, a vertical transfer register section placed so as to correspond to each of the columns of the light sensing sections, a horizontal transfer register section, and a vertical overflow drain structure placed at the last stages of the vertical transfer register sections adjacent to the horizontal transfer register section.

In the electronic apparatus according to this embodiment, the built-in solid-state imaging device includes the vertical overflow drain structure at the last stages of the vertical transfer register sections. Accordingly, in the case where charges obtained by adding unnecessary charges to signal charges are transferred in the vertical transfer register sections, when the unnecessary charges reach transfer portions at the last stages of the vertical transfer register sections, the vertical overflow drain structure allows the unnecessary charges to flow in the depth direction of the substrate of the device.

In the solid-state imaging device according to the foregoing embodiment of the present invention, the vertical overflow drain structure is placed at the last stages of the vertical transfer register sections. Accordingly, unnecessary charges, serving as smear signals, generated in the vertical transfer register sections are allowed to flow to the vertical overflow drain structure, so that the unnecessary charges are prevented from being transferred to the horizontal transfer register section. Advantageously, even when a large amount of light is received, an image defect is not caused, so that a high-quality image can be obtained.

Since the electronic apparatus according to the foregoing embodiment of the present invention includes the above-described solid-state imaging device, an image defect is not caused even when a large amount of light is received, so that a high-quality image can be obtained. Accordingly, the electronic apparatus with high reliability can be obtained.

### BRIEF DESCRIPTION OF THE DRAWINGS

FIG. 1 is a schematic diagram of the structure of a CCD solid-state imaging device according to an embodiment of the present invention;

FIG. 2 is a plan view of substantial part of a CCD solid-state imaging device according to a first embodiment of the present invention;

FIG. 3 is a cross-sectional view taken along the line III-III in FIG. 2;

FIG. 4 is a cross-sectional view taken along the line IV-IV in FIG. 2;

FIG. 5 is a cross-sectional view taken along the line V-V in FIG. 3;

FIG. 6 is a diagram illustrating a potential distribution taken along the line VI-VI in FIG. 3;

FIG. 7 is a plan view of substantial part of a CCD solid-state imaging device according to a second embodiment of the present invention;

FIG. 8 is a cross-sectional view taken along the line VIII-VIII in FIG. 7:

FIG. 9 is a plan view of substantial part of a CCD solid-state imaging device according to a third embodiment of the present invention;

FIG. 10 is a cross-sectional view taken along the line X-X in FIG. 9;

FIG. 11 is a plan view of substantial part of a CCD solid-state imaging device according to a fourth embodiment of the present invention;

FIG. 12 is a cross-sectional view taken along the line XII-XII in FIG. 11; and

FIG. 13 is a schematic diagram of the configuration of a camera as an example of an electronic apparatus according to an embodiment of the present invention.

### DESCRIPTION OF THE PREFERRED EMBODIMENTS

Embodiments of the present invention will be described below with reference to the drawings.

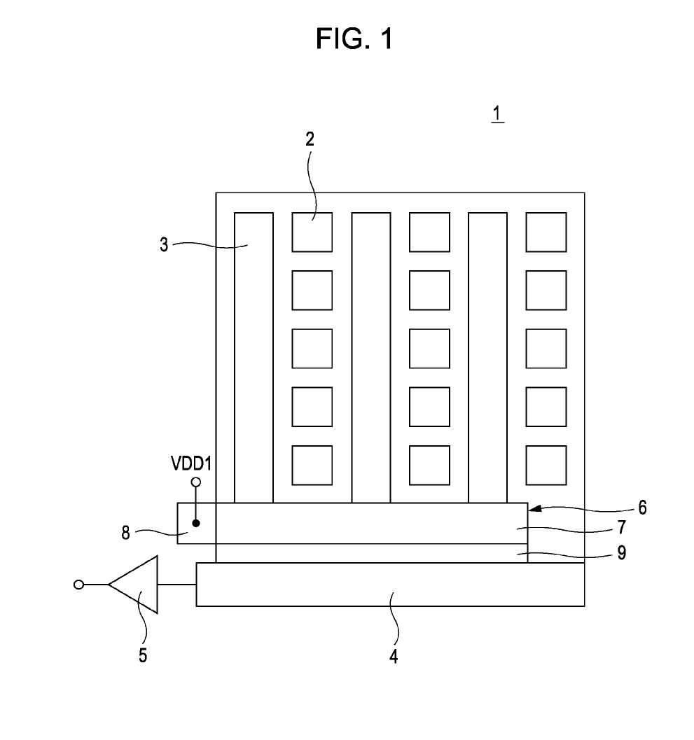

FIG. 1 illustrates the schematic structure of a solid-state imaging device, or a CCD solid-state imaging device according to a preferred embodiment of the present invention. Although the CCD solid-state imaging device of the interline transfer (IT) type will be described in this embodiment, the present invention is also applicable to a frame interline transfer (FIT) CCD solid-state imaging device.

Referring to FIG. 1, the solid-state imaging device, indicated at 1, according to this embodiment includes a plurality of light sensing sections 2, arranged two-dimensionally in rows and columns, for performing photoelectric conversion, a vertical transfer register section 3 having a CCD structure placed so as to correspond to each of the columns of the light sensing sections 2, and a horizontal transfer register section 4 having the CCD structure. The horizontal transfer register section 4 is placed so as to connect to the last stage of each vertical transfer register section 3. The last stage of the horizontal transfer register section 4 is connected through a floating transfer portion, serving as a charge-to-voltage conversion section, to an output section 5 that outputs a pixel signal. Each light sensing section 2 includes a photodiode. One light sensing section 2 and part of the corresponding vertical transfer register section 3 constitute a unit pixel. The solid-state imaging device 1 includes a driving circuit that drives the solid-state imaging device and a processing circuit that processes a signal output from the solid-state imaging device, those circuits being not illustrated in the figure.

According to the embodiment, especially at the last stages of the vertical transfer register sections 3, a first vertical-to-horizontal transfer gate section 7 including a vertical overflow drain structure 6 is provided. A second vertical-to-horizontal transfer gate section 9 constituting part of the last stages of the vertical transfer register sections 3 is placed between the first vertical-to-horizontal transfer gate section 7 including the vertical overflow drain structure 6 and the horizontal transfer register section 4.

As will be apparent from the following description, the vertical overflow drain structure 6 is constructed by forming a drain region under a transfer channel region with an overflow barrier region therebetween and connecting a voltage supply section 8 for supply of a predetermined drain voltage to one end of the drain region in the horizontal direction. In this embodiment, a power supply voltage VDD1 is applied as the drain voltage.

In the solid-state imaging device 1 according to the embodiment, light incident on each light sensing section 2 is converted into a signal charge according to the amount of incident light and the signal charge is stored in the light sensing section 2. The signal charge is read out from the light sensing section 2 to the corresponding vertical transfer register section 3. Unnecessary charges, serving as smear signals, generated in the vertical transfer register sections 3 upon reception of a large amount of light are combined with signal charges and the combined charges are transferred on a row-by-row basis in the transfer direction in the vertical transfer register sections 3. When the combined charges are transferred to transfer portions at the last stages of the vertical transfer register sections 3, only the unnecessary charges overflow into the drain region in the vertical direction through the overflow barrier region in the vertical overflow drain structure 6, so that the unnecessary charges are discharged from the voltage supply section 8 located in the end of the drain region. In this instance, the unnecessary charges are overflowing charges exceeding a potential for the vertical transfer register sections 3.

### First Embodiment

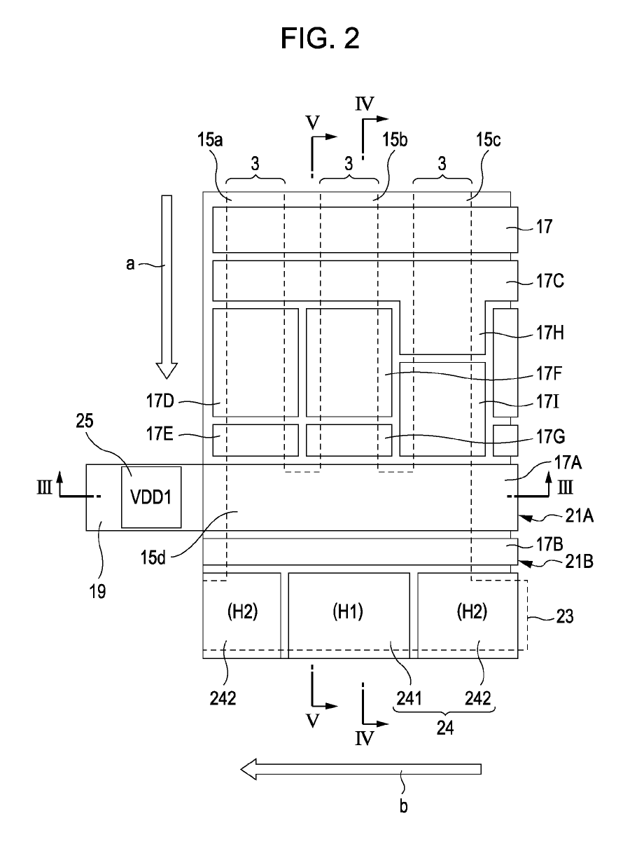

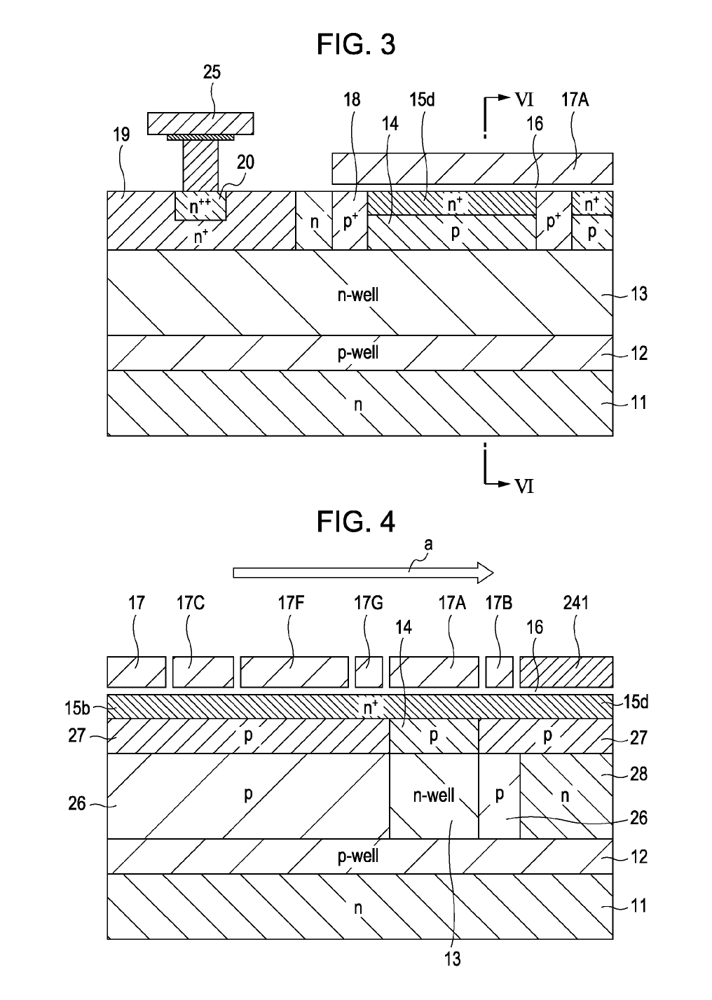

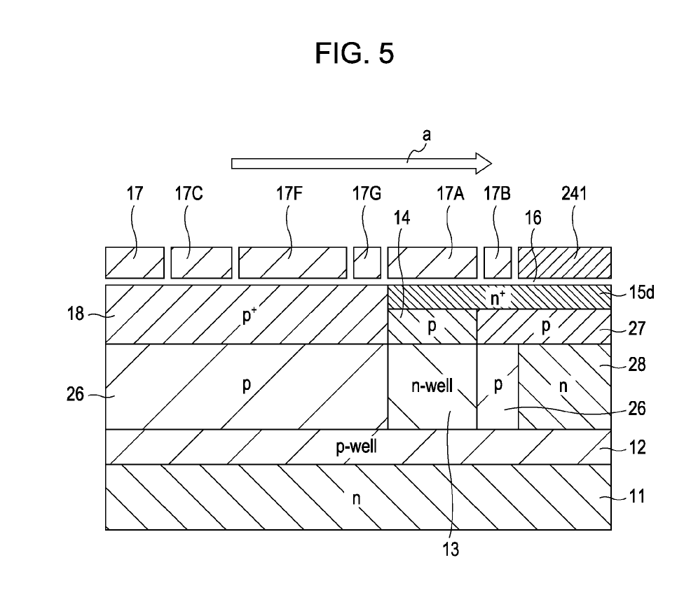

FIGS. 2 to 5 illustrate a CCD solid-state imaging device according to a first embodiment of the present invention. FIG. 2 illustrates substantial part, including end parts of vertical transfer register sections and a horizontal transfer register section, of the solid-state imaging device. FIG. 3 is a cross-sectional view taken along the line III-III in FIG. 2 (plan view). FIG. 4 is a cross-sectional view taken along the line IV-IV in FIG. 2. FIG. 5 is a cross-sectional view taken along the line V-V in FIG. 2.

Referring to FIG. 2 (plan view), the solid-state imaging device, indicated at 101, according to the first embodiment includes a vertical transfer channel region (hereinafter, simply referred to as “transfer channel region”) 15 for vertical transfer register sections 3. The solid-state imaging device 101 further includes a plurality of vertical transfer electrodes 17 extending in the horizontal direction above the transfer channel region 15 with a gate insulating layer therebetween such that the transfer electrodes 17 are arranged in the vertical direction. The vertical transfer register sections 3 include the transfer channel region 15, which includes three transfer channel region segments 15a, 15b, and 15c arranged in the horizontal direction such that the three transfer channel region segments are combined in transfer portions at the last stages of the vertical transfer register sections 3 in the vertical transfer direction (a). In other words, a combined transfer channel region segment 15d is placed in the transfer portions at the last stages. Channel stop regions 18 are disposed so as to be in contact with the respective transfer channel region segments 15a, 15b, 15c, and 15d.

In the transfer portions at the last stages of the vertical transfer register sections 3, a first vertical-to-horizontal transfer gate section 7 and a second vertical-to-horizontal transfer gate section 9 are arranged such that the respective gate sections are shared by the respective vertical transfer register sections 3. The first vertical-to-horizontal transfer gate section 7 includes a first vertical-to-horizontal transfer gate electrode 17A. The second vertical-to-horizontal transfer gate section 9 includes a second vertical-to-horizontal transfer gate electrode 17B. In transfer portions at end parts next to the transfer portions at the last stages, independent vertical transfer electrodes are arranged for the three transfer channel region segments 15a, 15b, and 15c, respectively. Specifically, as for the transfer channel region segment 15a, a vertical transfer electrode 17D and another vertical transfer electrode 17E are independently disposed between a vertical transfer electrode 17C provided in common to all of the transfer channel region segments and the first vertical-to-horizontal gate electrode 17A located at the last stages. As for the transfer channel region segment 15b, a vertical transfer electrode 17F and another vertical transfer electrode 17G are independently arranged between the vertical transfer electrode 17C common to the transfer channel region segments and the first vertical-to-horizontal transfer gate electrode 17A at the last stages. As for the transfer channel region segment 15c, a vertical transfer electrode 17H extending in the vertical transfer direction (a) from the vertical transfer electrode 17C common to the transfer channel region segments and a vertical transfer electrode 17I are independently arranged.

The horizontal transfer register section 4 is placed so as to connect to the transfer portions at the last stages of the vertical transfer register sections 3. In the horizontal transfer register section 4, horizontal transfer electrodes 24 (241, 242) to which two-phase clock pulses φH1 and φH2 are applied, respectively, are arranged above a horizontal transfer channel region (hereinafter, referred to as “transfer channel region”) 23 extending in the horizontal transfer direction (b) with the gate insulating layer therebetween. The above-described transfer electrodes 17, 17A to 17I, 241, and 242 are made of, for example, a polysilicon film.

In this embodiment, a vertical overflow drain structure 6 for drawing off unnecessary charges, serving as smear signals, is provided under the transfer portions at the last stages of the vertical transfer register sections 3, i.e., the first vertical-to-horizontal transfer gate section 7 at the last stages. The vertical overflow drain structure 6 is provided in common to the respective vertical transfer register sections 3.

The solid-state imaging device 101 will be described in more detail below with reference to the semiconductor cross-sectional structure shown in FIGS. 3 to 5. Referring to FIG. 3, the solid-state imaging device 101 according to the first embodiment includes a semiconductor substrate 11 of a first conductivity type, e.g., an n-type in this embodiment. A first well region 12 of a second conductivity type, i.e., a p-type in this embodiment is provided in the n-type semiconductor substrate 11. On the first p-type semiconductor well region 12, a drain region 13 is provided as an n-type semiconductor well region in a portion under the first vertical-to-horizontal transfer gate section 7. On the n-type drain region 13, an overflow barrier region 14 is provided as a second p-type semiconductor well region.

In addition, on the p-type overflow barrier region 14, the combined transfer channel region segment 15d obtained by combining the three transfer channel region segments 15a, 15b, and 15c is provided as an n-type transfer channel region. The first vertical-to-horizontal transfer gate electrode 17A is placed above the combined transfer channel region segment 15d with the gate insulating layer, indicated at 16, therebetween. In the first vertical-to-horizontal transfer gate section 7, the p-type channel stop regions 18 are arranged so as to reach the n-type drain region 13 in order to be in contact with the n-type combined transfer channel region segment 15d and be further in contact with the p-type overflow barrier region 14. In one end of the n-type drain region 13 in the horizontal direction, an n-type semiconductor region 19 doped more heavily than the n-type drain region 13 is placed so as to appear on the surface of the substrate. In the n-type semiconductor region 19, an n-type electrode lead-out region 20 doped more heavily than the region 19 is provided. The electrode lead-out region 20 is connected to a wiring line 25 through which a drain voltage (e.g., VDD1) is supplied. The wiring line 25, the electrode lead-out region 20, and the n-type semiconductor region 19 constitute a voltage supply section 8.

The n-type combined transfer channel region segment 15d, the gate insulating layer 16, and the first vertical-to-horizontal transfer gate electrode 17A constitute the first vertical-to-horizontal transfer gate section 7. The p-type overflow barrier region 14 located under the first vertical-to-horizontal transfer gate section 7, the n-type drain region 13, and the voltage supply section 8 that supplies the power supply voltage VDD1 to the drain region 13 constitute the vertical overflow drain structure 6.

Referring to FIG. 4, the second vertical-to-horizontal transfer gate section 9, located at the last stages of the vertical transfer register sections 3 connected to the horizontal transfer register section 4, includes in series the n-type combined transfer channel region segment 15d, the gate insulating layer 16, and the second vertical-to-horizontal transfer gate electrode 17B. A fourth p-type semiconductor well region 27 is located under the combined transfer channel region 15d constituting the second vertical-to-horizontal transfer gate section 9. In this portion, the fourth p-type semiconductor well region 27 overlies a third p-type semiconductor well region 26. The first p-type semiconductor well region 12 is located under the third p-type semiconductor well region 26.

Referring to FIGS. 4 and 5, the horizontal transfer register section 4 includes in series the n-type transfer channel region 23, which extends from the n-type combined transfer channel region segment 15d for the vertical transfer register sections 3 and also extends in the horizontal direction, the gate insulating layer 16, and the two-phase driven horizontal transfer electrodes 24 (241, 242). Under the transfer channel region 23, the fourth p-type semiconductor well region 27 is provided. The fourth p-type semiconductor well region 27 located under the horizontal transfer register section 4 overlies an n-type semiconductor region (corresponding to the remaining portion of the n-type semiconductor substrate) 28, which overlies the first p-type semiconductor well region 12.

Referring to FIG. 5, the p-type channel stop region 18 between the adjacent vertical transfer register sections 3 is located on the third p-type semiconductor well region 26.

Each light sensing section 2 (not shown) includes a photodiode that includes an n-type semiconductor region and a p+ accumulation layer, including a p-type semiconductor region for suppressing dark current, such that the accumulation layer is located on the n-type semiconductor region. Under the light sensing section 2, a vertical overflow drain structure is provided in order to allow a charge in the electronic shuttering operation and an excess charge, generated in the light sensing section 2 upon reception of a large amount of light, to flow to the substrate. Accordingly, an overflow barrier region, including a p-type semiconductor well region, is provided under the photodiode serving as the light sensing section 2. The drain region, serving as the n-type semiconductor substrate 11, is located under the overflow barrier region. Thus, the vertical overflow drain structure is provided. During a light receiving storage period, a predetermined substrate voltage is applied to the n-type semiconductor substrate 11. During the electronic shuttering operation, a higher substrate voltage than the predetermined substrate voltage is applied to the semiconductor substrate 11.

An operation of the solid-state imaging device 101 according to the first embodiment, in particular, an operation of the vertical overflow drain structure 6 placed at the last stages of the vertical transfer register sections 3 will now be described.

The vertical overflow drain structure 6 provided at the last stages of the vertical transfer register sections 3 is electrically isolated from the semiconductor substrate 11 by the first p-type semiconductor well region 12. The drain region 13 in the vertical overflow drain structure 6 is supplied with a predetermined drain voltage (e.g., the voltage VDD1) independent of any substrate voltage applied to the semiconductor substrate 11.

In the vertical transfer register sections 3, combined charges, including signal charges and unnecessary charges serving as smear signals, are transferred. When the combined charges are transferred to the first vertical-to-horizontal transfer gate section 7 at the last stages of the vertical transfer register sections 3, the unnecessary charges included in the combined charges transferred to the first vertical-to-horizontal transfer gate section 7 are discharged by the vertical overflow drain structure 6. Specifically, the unnecessary charges flow through the overflow barrier region 14 into the drain region 13 in the vertical direction, further flow in the drain region 13 in the horizontal direction, and after that, the necessary charges are discharged to the outside through the voltage supply section 8 located in the end of the drain region 13. The potential barrier of the p-type overflow barrier region 14 is controlled by controlling the drain voltage.

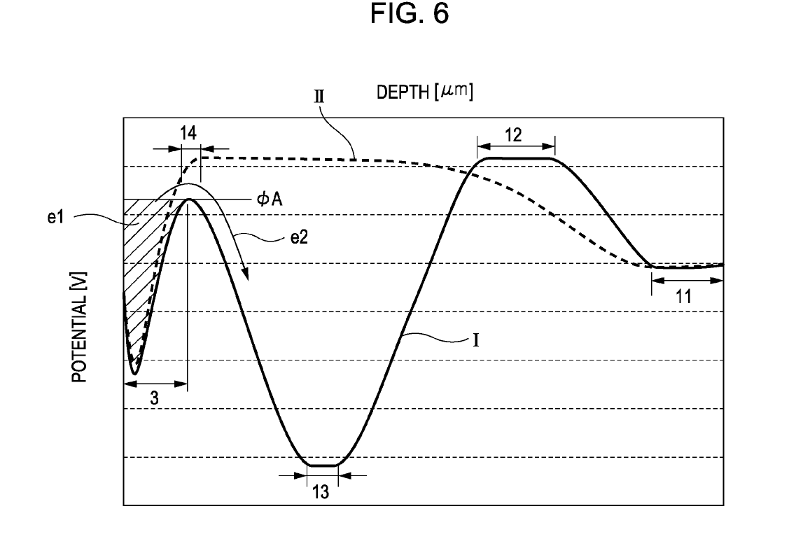

FIG. 6 is a diagram illustrating a potential distribution in the overflow drain structure, namely, a potential distribution in the depth direction of the substrate along the line VI-VI in FIG. 3. A solid line I indicates a potential distribution in the present embodiment. A dash line II represents a potential distribution of an imaging device having no overflow drain structure.

As shown by the solid line I, the drain voltage (VDD1) different from the substrate voltages is applied to the n-type drain region 13. An unnecessary charge e2, which is included in a combined charge (e1+e2) transferred in the first vertical-to-horizontal transfer gate section 7 and exceeds a potential of the vertical transfer register section, is discharged beyond a potential barrier φA of the overflow barrier region 14 toward the drain region 13 in the vertical direction of the substrate. A signal charge e1 is stored in the first vertical-to-horizontal transfer gate section 7. Accordingly, the unnecessary charge e2 is not transferred to the horizontal transfer register section 4.

While the signal charges are transferred in the horizontal transfer register section 4, signal charges of the pixels in the next row are stored and waited in the first vertical-to-horizontal transfer gate section 7. After signal charges of the pixels in the preceding row are read out, the first and second vertical-to-horizontal transfer gate sections 7 and 9 are driven so that the signal charges of the pixels in the next row waited in the first vertical-to-horizontal transfer gate section 7 are transferred to a transfer portion, supplied with the pulse φH1, of the horizontal transfer register section 4.

In the first embodiment, controlling transfer pulses that are applied to the vertical transfer electrodes 17C to 17C permits signal charges in the three vertical transfer channel region segments 15a, 15b, and 15c to be simultaneously transferred to the combined transfer channel region segment 15d. Alternatively, controlling the transfer pulses permits a signal charge in one or two of the three vertical transfer channel region segments to be selected and transferred to the combined transfer channel region segment 15d and also permits signal charges in the remaining vertical transfer channel region segments to be discharged. In other words, signal charges of the pixels in the horizontal direction can be thinned out in the way to be read out every other pixel.

In the solid-state imaging device 101 according to the first embodiment, the vertical overflow drain structure 6 at the last stages of the vertical transfer register sections 3 prevents such a problem that unnecessary charges, serving as smear signals, generated upon reception of a large amount of light are not stored by the vertical transfer register sections and the unnecessary charges are transferred to the horizontal transfer register section 4. Accordingly, an image defect is not caused even when a large amount of light is received.

If a lateral overflow drain structure is provided in an effective area adjacent to the vertical transfer register sections, a variation in overflow potential significantly affects the amount of charge stored in each vertical transfer register section. Accordingly, a mechanism for increasing controllability of the overflow potential has to be devised. This mechanism is a very difficult challenge, especially to miniaturization of unit pixels. According to the first embodiment, a vertical transfer register alone is provided at the last stage of each vertical transfer register section 3, so that a storage area can be ensured. Accordingly, the arrangement is robust against a variation in the amount of stored charge, the variation being caused by a fluctuation of overflow drain. In other words, since the storage area is large and the amount of charge handled is large, even when overflow drain fluctuates, the amount of charge handled is prevented from being insufficient. Thus, the functions of the vertical transfer registers are hardly influenced.

As compared to the lateral overflow drain structure, it is unnecessary in the vertical overflow drain structure to provide a contact to the semiconductor substrate in the vicinity of the vertical transfer register sections. Accordingly, there is no restriction upon manufacture. Even when the miniaturization of unit pixels is achieved, unnecessary charges can be discharged with efficiency. Since the unnecessary charges are discharged from the vertical transfer register sections directly to the drain region, the overflow barrier potential can be controlled independently of the substrate voltages for the light sensing sections.

Furthermore, it is unnecessary to provide a pulse φVSUB as a substrate voltage disclosed in Japanese Unexamined Patent Application Publication No. 6-339081.

Since the vertical overflow drain structure 6 is electrically isolated from the n-type semiconductor substrate 11, the potential of the drain region 13 is not affected by any substrate voltage, so that the potential of the drain region 13 does not fluctuate. In addition, since the drain region 13 is supplied with a voltage independent of the substrate voltages, the potential barrier in the overflow barrier region 14 can be reliably set without varying.

### Second Embodiment

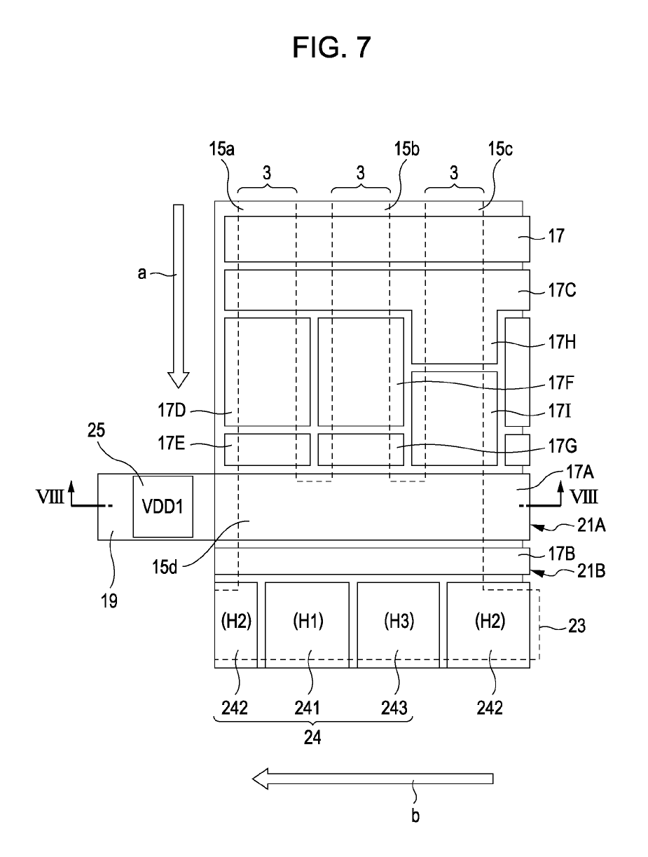

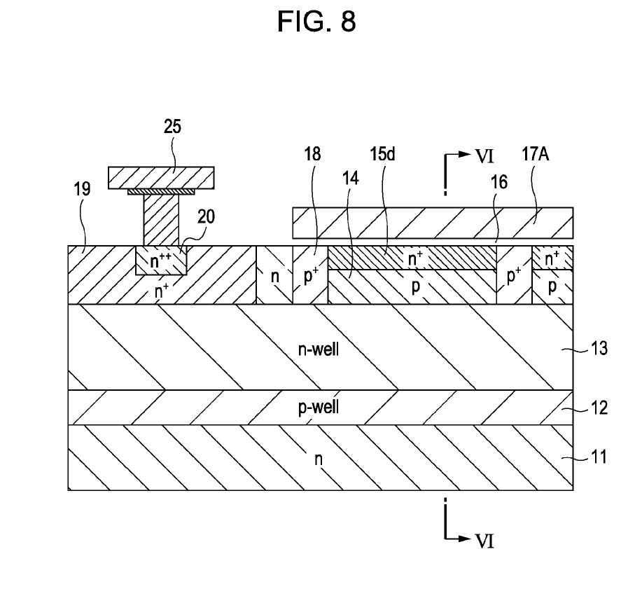

FIGS. 7 and 8 illustrate a CCD solid-state imaging device according to a second embodiment of the present invention. FIG. 7 (plan view) illustrates substantial part, including end parts of vertical transfer register sections and a horizontal transfer register section, of the solid-state imaging device. FIG. 8 is a cross-sectional view taken along the line VIII-VIII in FIG. 7 (plan view).

Referring to FIG. 7 (plan view), the solid-state imaging device, indicated at 102, according to the second embodiment includes a transfer channel region 15 for the vertical transfer register sections, indicated at 3, and further includes a plurality of vertical transfer electrodes 17 disposed above the transfer channel region 15 with a gate insulating layer therebetween. The vertical transfer register sections 3 include the transfer channel region 15, which includes three transfer channel region segments 15a, 15b, and 15c arranged in the horizontal direction such that the three transfer channel region segments are combined in transfer portions at the last stages of the vertical transfer register sections 3 in the vertical transfer direction (a). In other words, a combined transfer channel region segment 15d is placed in the transfer portions at the last stages.

The horizontal transfer register section, indicated at 4, includes a horizontal transfer channel region 23 extending in the horizontal transfer direction (b) from the combined transfer channel region segment 15d and horizontal transfer electrodes 24 disposed above the transfer channel region 23 with the gate insulating layer therebetween. In the present embodiment, the horizontal transfer electrodes 24 include horizontal transfer electrodes 241, 242, and 243 to which three-phase driving pulses φH1, φH2, and φH3 are applied, respectively.

In this embodiment, a first vertical-to-horizontal transfer gate section 7, which constitutes the transfer portions at the last stages of the vertical transfer register sections 3, includes a vertical overflow drain structure 6 similar to the first embodiment. As shown in FIG. 8, the specific cross-section of the vertical overflow drain structure 6 in the embodiment is the same as that in FIG. 3. Since the arrangement in the second embodiment is the same as that in the first embodiment except for the horizontal transfer register section 4 is driven in a three-phase manner, the same components as those in FIGS. 2 and 3 are designated by the same reference numerals and redundant description thereof is omitted.

In the second embodiment, signal charges stored in the first vertical-to-horizontal transfer gate section 7 are transferred to a transfer portion, to which the driving pulse φH1 is applied, of the horizontal transfer register section 4. An operation of the vertical overflow drain structure 6 is the same as that in the first embodiment.

In the solid-state imaging device 102 according to the second embodiment, the vertical overflow drain structure 6 electrically isolated from the semiconductor substrate 11 is provided at the last stages of the vertical transfer register sections 3 in the same way as the first embodiment. With this arrangement, the same advantages as those of the first embodiment are obtained. For example, unnecessary charges, serving as smear signals, generated upon reception of a large amount of light are prevented from being transferred to the horizontal transfer register section 4.

### Third Embodiment

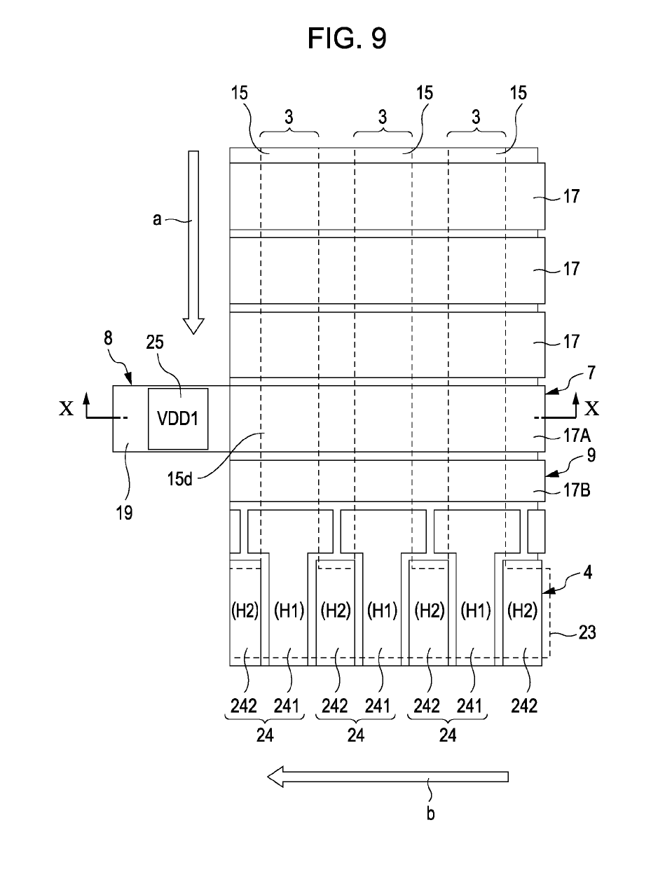

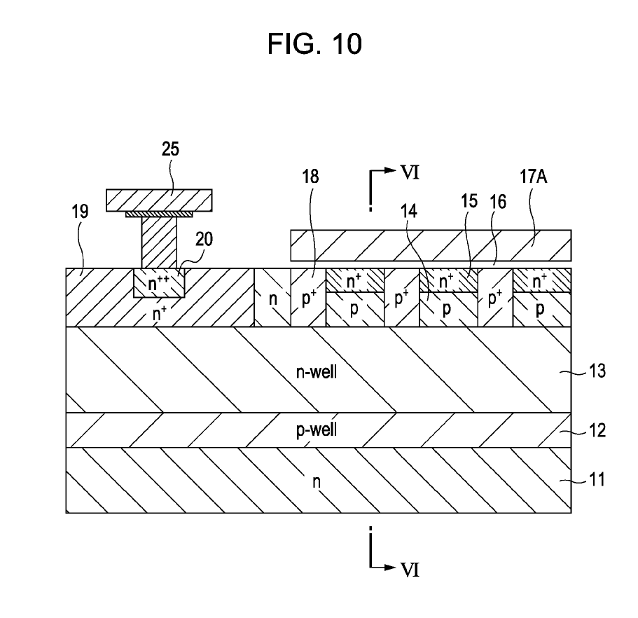

FIGS. 9 and 10 illustrate a CCD solid-state imaging device according to a third embodiment of the present invention. FIG. 9 (plan view) illustrates substantial part, including end parts of vertical transfer register sections and a horizontal transfer register section, of the solid-state imaging device. FIG. 10 is a cross-sectional view taken along the line X-X in FIG. 9.

Referring to FIG. 9 (plan view), the solid-state imaging device, indicated at 103, according to the third embodiment includes transfer channel regions 15 provided for respective vertical transfer register sections 3 and a plurality of vertical transfer electrodes 17 disposed above the transfer channel regions 15 with a gate insulating layer therebetween. A horizontal transfer register section 4 includes a horizontal transfer channel region 23 connected to the transfer channel regions 15 for the vertical transfer register sections 3 and a plurality of horizontal transfer electrodes 24, which are arranged above the horizontal transfer channel region 23 with the gate insulating layer therebetween. The horizontal transfer electrodes 24 include horizontal transfer electrodes 241 and 242, to which two-phase driving pulses φH1 and φH2 are applied, respectively. The horizontal transfer electrodes 241 project closer to the vertical transfer register sections 3 than the horizontal transfer electrodes 242. Each horizontal transfer electrode 241 is T-shaped. Each vertical transfer register section 3 is connected to a transfer portion, to which the driving pulse φH1 is applied, of the horizontal transfer register section 4.

In the present embodiment, a first vertical-to-horizontal transfer gate section 7, constituting transfer portions at the last stages of the vertical transfer register sections 3, includes a vertical overflow drain structure 6 similar to the first embodiment. As shown in FIG. 10, the specific cross-section of the vertical overflow drain structure 6 in the embodiment is similar to that in FIG. 3. A second vertical-to-horizontal transfer gate section 9 is placed between the first vertical-to-horizontal transfer gate section 7 and the horizontal transfer register section 4. The other arrangement is the same as that described in the first embodiment. In FIGS. 9 and 10, the same components as those in FIGS. 2 and 3 are designated by the same reference numerals and redundant description thereof is omitted.

In the solid-state imaging device 103 according to the third embodiment, the vertical overflow drain structure 6 electrically isolated from the semiconductor substrate 11 is provided at the last stages of the vertical transfer register sections 3. With this arrangement, the same advantages as those described in the first embodiment are obtained. For example, unnecessary charges, serving as smear signals, generated upon reception of a large amount of light are prevented from being transferred to the horizontal transfer register section.

### Fourth Embodiment

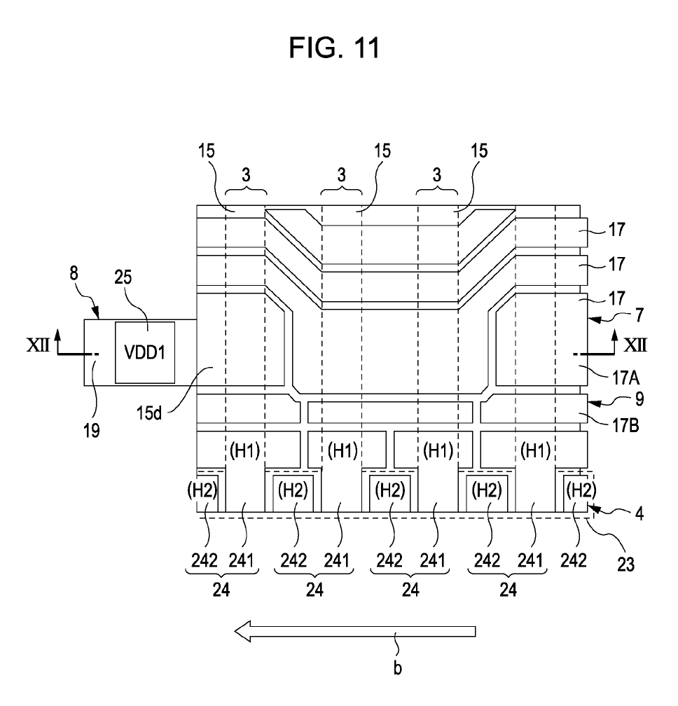

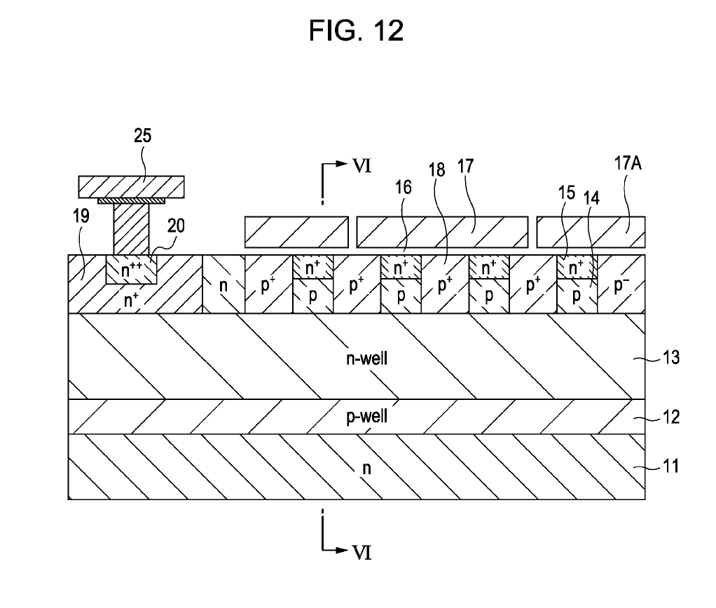

FIGS. 11 and 12 illustrate a solid-state imaging device according to a fourth embodiment of the present invention. FIG. 11 (plan view) illustrates substantial part, including end parts of vertical transfer register sections and a horizontal transfer register section, of the solid-state imaging device. FIG. 12 is a cross-sectional view taken along the line XII-XII in FIG. 11 (plan view).

Referring to FIG. 11 (plan view), the solid-state imaging device, indicated at 104, according to the fourth embodiment includes vertical transfer channel regions 15 provided for the vertical transfer register sections, indicated at 3, and a plurality of vertical transfer electrodes 17 arranged above the vertical transfer channel regions 15 with a gate insulating layer therebetween. The arrangement pattern of the vertical transfer electrodes 17 in end parts of the vertical transfer register sections 3 is different from that in the first embodiment. Each of first and second vertical-to-horizontal transfer gate sections 7 and 9, which constitute transfer portions at the last stages of the vertical transfer register sections 3, includes a plurality of electrode segments arranged in the horizontal direction so that a first vertical-to-horizontal transfer gate electrode segment 17A and a second vertical-to-horizontal transfer gate electrode segment 17B are shared by two vertical transfer channel regions 15. The horizontal transfer register section, indicated at 4, includes a horizontal transfer channel region 23 connected to the respective vertical transfer channel regions 15 of the vertical transfer register sections 3 and a plurality of horizontal transfer electrodes 24, which are arranged above the horizontal transfer channel region 23 with a gate insulating layer therebetween. The horizontal transfer electrodes 24 include horizontal transfer electrodes 241 and 242, to which two-phase driving pulses φH1 and φH2 are applied, respectively. The horizontal transfer electrodes 241 project closer to the vertical transfer register sections 3 than the horizontal transfer electrodes 242 and each have a T-shape. Each vertical transfer register section 3 is connected to a transfer portion, to which the driving pulse φH1 is applied, of the horizontal transfer register section 4.

In this embodiment, the first vertical-to-horizontal transfer gate section 7, constituting the transfer portions at the last stages of the vertical transfer register sections 3, includes a vertical overflow drain structure 6 similar to the first embodiment. As shown in FIG. 12, the specific cross-section of the vertical overflow drain structure 6 in the embodiment is similar to that shown in FIG. 3. The second vertical-to-horizontal transfer gate section 9 is placed between the first vertical-to-horizontal transfer gate section 7 and the horizontal transfer register section 4. The other arrangement is the same as that described in the first embodiment. In FIGS. 11 and 12, therefore, the same components as those in FIGS. 2 and 3 are designated by the same reference numerals and redundant description thereof is omitted.

In the solid-state imaging device 104 according to the fourth embodiment, the vertical overflow drain structure 6 electrically isolated from the semiconductor substrate 11 is provided at the last stages of the vertical transfer register sections 3. With this arrangement, the same advantages as those of the first embodiment are obtained. For example, unnecessary charges, serving as smear signals, generated upon reception of a large amount of light are prevented from being transferred to the horizontal transfer register section 4.

Although the above embodiments have been described on the assumption that a signal charge includes an electron, a signal charge may include a hole. In this case, the conductivity types of the respective semiconductor regions are opposite to those in the above embodiments.

In each of the above embodiments, the present invention is applied to the interline transfer (IT) CCD solid-state imaging device. The present invention is applicable to a frame interline transfer (FIT) CCD solid-state imaging device which includes an imaging area including light sensing sections and vertical transfer register sections, a storage portion including only the vertical transfer register sections, and a horizontal transfer register section. When the present invention is applied to the frame interline transfer CCD imaging device, the vertical overflow drain structure is provided at the last stages of the vertical transfer register sections in the storage portion.

The solid-state imaging device according to any of the embodiments of the present invention is available in electronic apparatuses, such as a digital still camera, a digital video camera, a camera-equipped mobile phone, and other apparatuses equipped with the solid-state imaging device.

### Electronic Apparatus

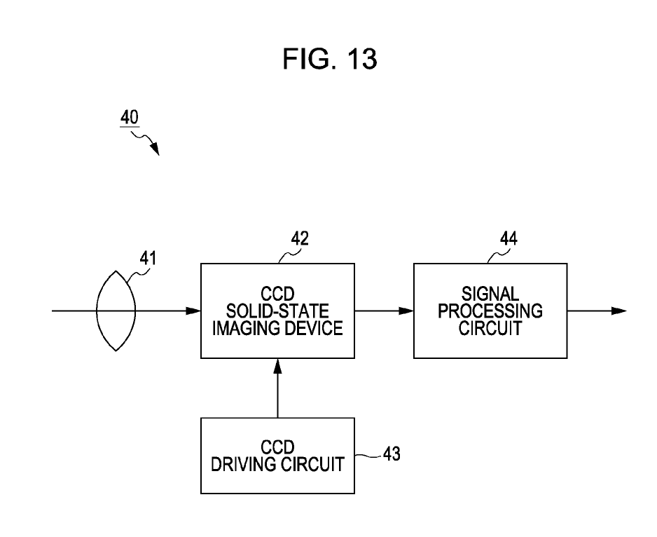

FIG. 13 illustrates a camera as an example of an electronic apparatus according to an embodiment of the present invention. The camera, indicated at 40, according to the present embodiment includes an optical system (optical lens) 41, a CCD solid-state imaging device 42, a CCD driving circuit 43, and a signal processing circuit 44. As for the CCD solid-state imaging device 42, any one of the solid-state imaging devices according to the above-described embodiments is used. The optical system 41 focuses imaging light (incident light) reflected from a subject on the imaging surface of the CCD solid-state imaging device 42. Consequently, each light sensing section (photoelectric conversion element) of the CCD solid-state imaging device 42 converts the imaging light into a signal charge according to the amount of incident light and stores the signal charge for a predetermined period of time. The CCD driving circuit 43 drives the CCD solid-state imaging device 42 so that the stored signal charges are read out to vertical transfer register sections, the signal charges are transferred in the vertical transfer register sections, the signal charges are transferred from the vertical transfer register sections to a horizontal transfer register section, and the signal charges are transferred in the horizontal transfer register section. The signal processing circuit 44 performs various signal processes on a signal output from the CCD solid-state imaging device 42 and outputs the resultant signal. The camera 40 according to this embodiment includes a camera module obtained by modularizing the optical system 41, the CCD solid-state imaging device 42, the CCD driving circuit 43, and the signal processing circuit 44.

According to the embodiment, a mobile phone including the camera or camera module in FIG. 13, typically, a camera-equipped mobile phone can be achieved.

Furthermore, the structure in FIG. 13 is realized as a module having an imaging function obtained by modularizing the optical system 41, the CCD solid-state imaging device 42, the CCD driving circuit 43, and the signal processing circuit 44, i.e., as an imaging function module. According to the embodiment, an electronic apparatus including the imaging function module can be achieved.

According to the electronic apparatus of the present embodiment, even when the CCD solid-state imaging device includes miniaturized pixels, smear signals (charges) generated in the vertical transfer register sections upon reception of a large amount of light are prevented from being transferred to the horizontal transfer register section. Thus, the electronic apparatus with high image quality can be provided.

The present application contains subject matter related to that disclosed in Japanese Priority Patent Application JP 2008-173625 filed in the Japan Patent Office on Jul. 2, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A solid-state imaging device comprising:
a plurality of light sensing sections disposed arranged two-dimensionally in rows and columns, each light sensing section performing photoelectric conversion;
a vertical transfer register section placed so as to correspond to each of the columns of the light sensing sections;
a horizontal transfer register section; and
a vertical overflow drain structure placed at the last stages of the vertical transfer register sections adjacent to the horizontal transfer register section.

2. The device according to claim 1, wherein the vertical overflow drain structure is electrically isolated from a semiconductor substrate of the device.

3. The device according to claim 2, wherein a drain region of the vertical overflow drain structure is supplied with a voltage independent of a substrate voltage.

4. The device according to claim 3, further comprising:
a first vertical-to-horizontal transfer gate section including the vertical overflow drain structure placed at the last stages of the vertical transfer register sections; and
a second vertical-to-horizontal gate section interposed between the first vertical-to-horizontal transfer gate section and the horizontal transfer register section.

5. The device according to claim 3, wherein the device includes a vertical overflow drain structure to allow an excess charge in the light sensing sections to flow to the semiconductor substrate.

6. The device according to claim 3, wherein
the vertical overflow drain structure placed at the last stages of the vertical transfer register sections includes:
the drain region of a first conductivity type, the drain region being located above the semiconductor substrate of the first conductivity type with a first semiconductor well region of a second conductivity type therebetween;
an overflow barrier region of the second conductivity type, the overflow barrier region being interposed between the first-conductivity type drain region and a vertical transfer channel region of the first conductivity type; and
a voltage supply section connected to one end of the drain region in the horizontal direction.

7. An electronic apparatus comprising:
a solid-state imaging device;
an optical system that guides incident light to light sensing sections of the solid-state imaging device;
a driving circuit that drives the solid-state imaging device; and
a signal processing circuit that processes an output signal of the solid-state imaging device, wherein
the solid-state imaging device includes
the light sensing sections arranged two-dimensionally in rows and columns, each light sensing section performing photoelectric conversion,
a vertical transfer register section placed so as to correspond to each of the columns of the light sensing sections,
a horizontal transfer register section, and
a vertical overflow drain structure placed at the last stages of the vertical transfer register sections adjacent to the horizontal transfer register section.

8. The apparatus according to claim 7, wherein
the vertical overflow drain structure in the solid-state imaging device is electrically isolated from a semiconductor substrate of the device, and
a drain region in the vertical overflow drain structure is supplied with a voltage independent of a substrate voltage.

9. The apparatus according to claim 8, wherein the solid-state imaging device includes a vertical overflow drain structure to allow an excess charge in the light sensing sections to flow to the semiconductor substrate.
